(19) United States
(12) Patent Application Publication
(10) Pub. No.: US 2006/0056509 A1
(43) Pub. Date: Mar. 16, 2006

(54) Image display apparatus, image display control method, program, and computer-readable medium

(76) Inventors: Tooru Suino, Kanagawa (JP); Satoshi Ouchi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/228,682

(22) Filed: Sep. 16, 2005

(30) Foreign Application Priority Data
Sep. 16, 2004 (JP) 2004-270313
May 16, 2005 (JP) 2005-142940

(51) Int. Cl. H04N 11/04; H04N 13/00; H04B 1/66; H04N 15/00; H04N 7/12; H04N 11/02

(52) U.S. Cl. 375/240.11; 375/240.19; 348/42

(57) ABSTRACT

An image display apparatus is disclosed that includes an image input unit configured to input plural images, a display image selection unit configured to select an image to be displayed from the images input by the image input unit, an image display unit configured to display the image selected by the display image selection unit, and an interest level recognition unit configured to determine whether an interest level of a user is high/low. The display image selection unit is configured to select the image to be displayed based on a determination result of the interest level recognition unit pertaining to the interest level of the user.

The present application claims priority to and incorporates by reference the entire contents of Japanese priority documents, 2004-270313 filed in Japan on Sep. 16, 2004, and 2005-142940 filed in Japan on May 5, 2005.

### BACKGROUND OF THE INVENTION

1. Field of the Invention

The present invention relates generally to an apparatus having image display functions (referred to as image display apparatus in the present application), and particularly to a technique implemented in such an image display apparatus for switching a display image in accordance with a state of a user.

2. Description of the Related Art

In the prior art, an image processing apparatus such as a digital video camera is known that detects the viewing direction of a camera operator and compresses (encodes) a region including the corresponding location of the viewing direction of a moving image or a succession of still images using a compression rate that is lower than that used for other regions of the image(s) (e.g., see Japanese Laid-Open Patent No. 2001-333430).

Also, Japanese Patent No. 3228086 discloses a driving aid apparatus having image capturing means that is arranged at the front side of the driver's seat of an automobile, the image capturing means is configured to capture an image of the face of the driver and detect the facing direction of the driver's face and the viewing direction of the driver based on the image capturing the face of the driver, and control the operation of the driving aid apparatus based on the detected facing direction and the viewing direction of the driver. A same type of viewing direction detection technique is also disclosed in Japanese Laid-Open Patent Publication No. 5-298015.

It is noted that various methods for pulse rate detection are known and practiced in the prior art. For example, a method of detecting a pulse rate using a reflective or transmissive optical pulse sensor is disclosed in Japanese Laid-Open Patent Publication No. 7-124131 and Japanese Laid-Open Patent Publication No. 9-253062. Also, a method of measuring a pulse rate using a pressure sensor is disclosed in Japanese Laid-Open Patent Publication No. 5-31085.

In recent years and continuing, apparatuses having sophisticated image display functions are becoming increasingly popular. For example, incorporation of cutting edge image display functions (e.g. displaying dynamic three-dimensional images, or displaying high-speed moving images) can be seen in pinball machines (also known as pachinko machines) and rhythm-based game machines. Such images may have the advantageous effects of exciting the user of the machine and increasing the amusement factor of the game. However, when such images are displayed to the user for a long period of time, the user may experience severe eye fatigue, for example.

### SUMMARY OF THE INVENTION

An image display apparatus, image display method, program, and computer-readable medium are described. In one embodiment, an image input unit to input multiple images, a display image selection unit to select an image to be displayed from the images input by the image input unit, an image display unit to display the image selected by the display image selection unit, and an interest level recognition unit to determine whether an interest level of a user is high/low; wherein the display image selection unit is to selects the image to be displayed based on a determination result of the interest level recognition unit pertaining to the interest level of the user.

### BRIEF DESCRIPTION OF THE DRAWINGS

FIG. 1 is a block diagram showing a configuration of an image display apparatus according to a first embodiment of the present invention;

FIG. 2 is a flowchart illustrating an image selection control process that is performed by a display image selection unit shown in FIG. 1;

FIG. 3 is a diagram illustrating the switching of moving images according to a change in the interest level of a user;

FIG. 4 is a block diagram showing an exemplary configuration of an interest level recognition unit;

FIG. 5 is a flowchart illustrating an exemplary configuration of a viewing direction calculating algorithm used in a viewing direction recognition processing unit shown in FIG. 4;

FIG. 6 is a diagram illustrating a viewing direction detection process;

FIG. 7 is a block diagram illustrating another exemplary configuration of the interest level recognition unit;

FIG. 8 is a front view of an exemplary image display apparatus;

FIG. 9 is a block diagram illustrating another exemplary configuration of the interest level recognition unit;

FIG. 10 is a block diagram illustrating a configuration of an image display apparatus according to a second embodiment of the present invention;

FIG. 11 is a flowchart illustrating an image selection control process that is performed by a display image selection unit shown in FIG. 10;

FIG. 12 is a block diagram illustrating the JPEG 2000 compression algorithm;

FIGS. 13A through 13D are diagrams illustrating the two-dimensional wavelet transform;

FIG. 14 is a diagram illustrating combshaped edges generated in interlaced moving images;

FIG. 15 is a flowchart illustrating an exemplary estimation algorithm used in a motion estimation unit shown in FIG. 10;

FIG. 16 is a flowchart illustrating a flesh color detection algorithm;

FIG. 17 is a flowchart illustrating a flesh color pixel detection algorithm;

FIG. 18 is a flowchart illustrating an iris/pupil pixel detection algorithm;

FIG. 19 is a flowchart illustrating an eyewhite pixel detection algorithm;

FIG. 20 is a flowchart illustrating an eye region detection algorithm; and

FIG. 21 is a diagram illustrating an eye region, an iris, and a pupil.

### DETAILED DESCRIPTION

Embodiments of the present invention overcome one or more of the problems of the related art. One embodiment of the present invention comprises an image display apparatus including a game apparatus such as a pachinko machine or a rhythm-based game machine and an image display control method that enables switching of a display image in accordance with the level of interest of a user so as to reduce the strain on the eyes of the user without decreasing the excitement/entertainment factor.

It is noted that switching a display image refers to selecting an image to be displayed from plural images. For example, such operation may involve switching an image to be displayed from a three-dimensional image to a two-dimensional image or vice versa, switching an image to be displayed from a moving image to a still image or vice versa, or switching an image to be displayed from a high-speed moving image to a low-speed moving image or vice versa. The interest level of the user refers to the interest of the user, which normally changes from time to time. An embodiment of the present invention recognizes such level of interest of the user, and selects an appropriate image to be displayed accordingly.

According to an embodiment of the present invention, an image display apparatus includes an image input unit configured to input plural images; a display image selection unit to select an image to be displayed from the images input by the image input unit; an image display unit to display the image selected by the display image selection unit; and an interest level recognition unit to determine whether an interest level of a user is high/low; wherein the display image selection unit operates to select the image to be displayed based on the determination result of the interest level recognition unit pertaining to the interest level of the user.

According to another embodiment of the present invention, an image display apparatus is includes: an image input unit to input plural moving images; a display image selection unit to select a moving image to be displayed from the moving images input by the image input unit; an image display unit to display the moving image selected by the display image selection unit; an interest level recognition unit to determine whether an interest level of a user is high/low; and a motion estimation unit to estimate the amount of motion in each of the moving images; wherein the display image selection unit operates to detect a moving image with the smallest amount of motion of the input moving images based on the amount of motion in each of the moving images estimated by the motion estimation unit and selects the moving image with the smallest amount of motion when the interest level recognition unit determines that the interest level of the user is low, and detects a moving image with the largest amount of motion of the input moving images based on the amount of motion in each of the moving images estimated by the motion estimation unit and selects the moving image with the largest amount of motion when the interest level determination unit determines that the interest level of the user is high.

According to another embodiment of the present invention, an image display control method for controlling an image display operation of an image display apparatus is provided, where the method includes selecting an image to be displayed from plural images; and determining whether an interest level of a player is high/low; wherein the image to be displayed is selected based on the determination result pertaining to the interest level of the user.

According to another embodiment of the present invention, an image display control method for controlling an image display operation of an image display apparatus is provided where the method includes selecting a moving image to be displayed from plural moving images; estimating the amount of motion in each of the moving images; and determining whether an interest level of a player is high/low; wherein the display image selection includes detecting a moving image with the smallest amount of motion of the moving images based on the amount of motion in each of the moving images that is estimated and selecting the moving image with the smallest amount of motion when the interest level of the user is determined to be low, and detecting a moving image with the largest amount of motion of the moving images based on the amount of motion in each of the moving images that is estimated and selecting the moving image with the largest amount of motion when the interest level of the user is determined to be high.

According to another embodiment of the present invention, a program run on a computer for controlling an image display operation is provided, the program is executed by the computer to realize the functions of the image display apparatus of the present invention.

According to another embodiment of the present invention, a computer-readable medium is provided that contains a program run on a computer and executed by the computer to realize the functions of the image display apparatus of the present invention.

In the following, preferred embodiments of the present invention are described with reference to the accompanying drawings.

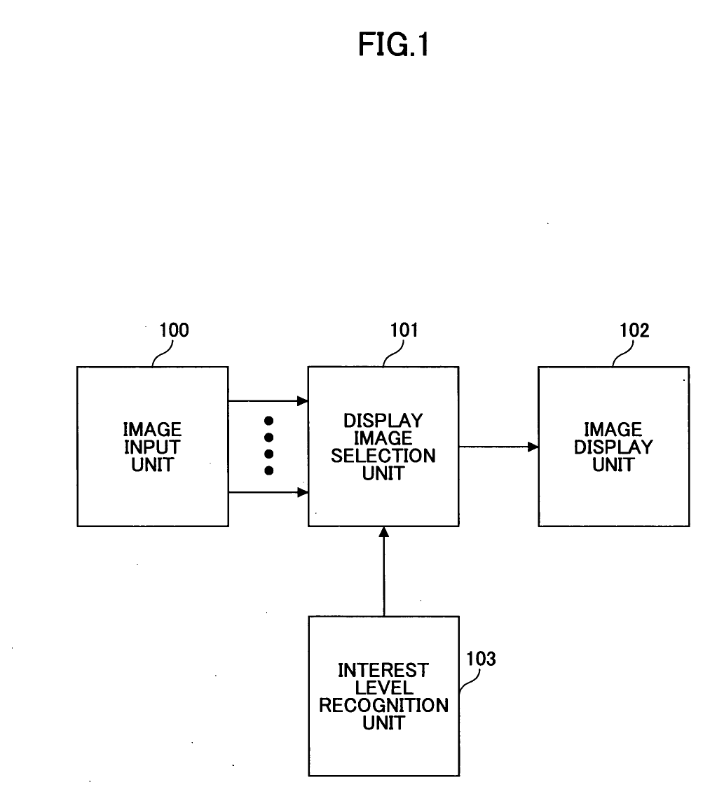

FIG. 1 is a block diagram showing a configuration of an image display apparatus according to a first embodiment of the present invention. The image display apparatus of the present embodiment may correspond to a game apparatus such as a pachinko machine or a rhythm-based game machine, for example, and includes an image input unit 100 that inputs at least two images that are prepared beforehand, a display image selection unit 101 that selects (switches) an image to be displayed from the images input by the image input unit 100, an image display unit 102 that displays the image selected by the image selection unit 101 on a screen, and an interest level recognition unit 103 for determining whether the interest level of a user using the present image display apparatus is high/low. The interest level recognition unit 103 is configured to output a signal indicating the determination result pertaining to the interest level of the user, and in turn, this signal is input to the display image selection unit 101. In this way, the display image selection unit 101 may be informed of the interest level of the user.

According to the present embodiment, the images input by the image input unit 100 correspond to pixel data that may be readily displayed. In one embodiment, the image input unit 100 may be configured to read the images from a large-capacity storage device or a large-capacity storage medium and input the read images. In another embodiment, the image input unit 100 may be configured to read image data that are stored as compressed code data in a large-capacity storage device or a large-capacity storage medium, decode the read image data, and input the decoded image data. In yet another example, the image input unit 100 may be configured to receive code data of the images via a network, decode the received image data, and input the decoded image data.

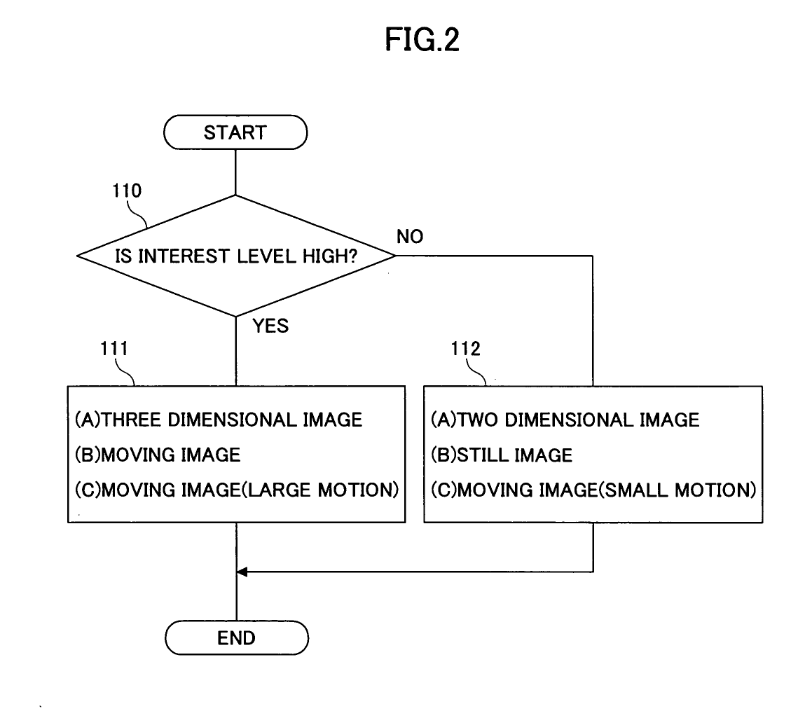

FIG. 2 is a flowchart illustrating an image selection control process that is performed by the display image selection unit 101. The display image selection unit 101 maybe configured to check the output signal of the interest level recognition unit 103 at predetermined time intervals to determine whether the current interest level of the user determined by the interest level recognition unit 103 is high/low (step 110). If the interest level of the user is determined to be high (step 110, Yes), an image that has an effect of increasing the excitement factor of the game is selected from the images input by the image input unit 100 (step 111). If the interest level of the user is determined to be low (step 110, No), an image with reduced strain on the eyes of the user is selected from the images input by the image input unit 100 (step 112). In the following, specific examples of the image selection control process are described.

According to one example, images input by the image input unit 100 include a three dimensional image with a high impact and a two-dimensional image with reduced strain on the eyes of the user. In this case, the three dimensional image is selected in step 111, and the two-dimensional image is selected in step 112. In other words, in a case where a three dimensional image and a two-dimensional image are provided, the three dimensional image with a high impact is selected when the user is highly interested in the game, and the two-dimensional image with reduced strain on the eyes of the user is selected when the user is not so interested in the game.

According to another example, the images input by the image input unit 100 include a moving image and a still image. In this case, the moving image is selected in step 111, and the still image is selected in step 112. In other words, in a case where a moving image and a still image are provided, a moving image with greater dynamism is selected when the interest level of the user is high, and the still image with reduced strain on the eyes of the user is selected when the interest level of the user is low.

According to yet another example, the images input by the image input unit 100 include a moving image containing a large amount of motion and a moving image containing a small amount of motion. In this case, the image containing a large amount of motion is selected in step 111, and the image containing a small amount of motion is selected in step 112. In other words, in a case where an image with a large amount of motion and an image with a small amount of motion are provided, the image with a large amount of motion is selected when the interest level of the user is high, and the image with a small amount of motion is selected when the interest level of the user is low.

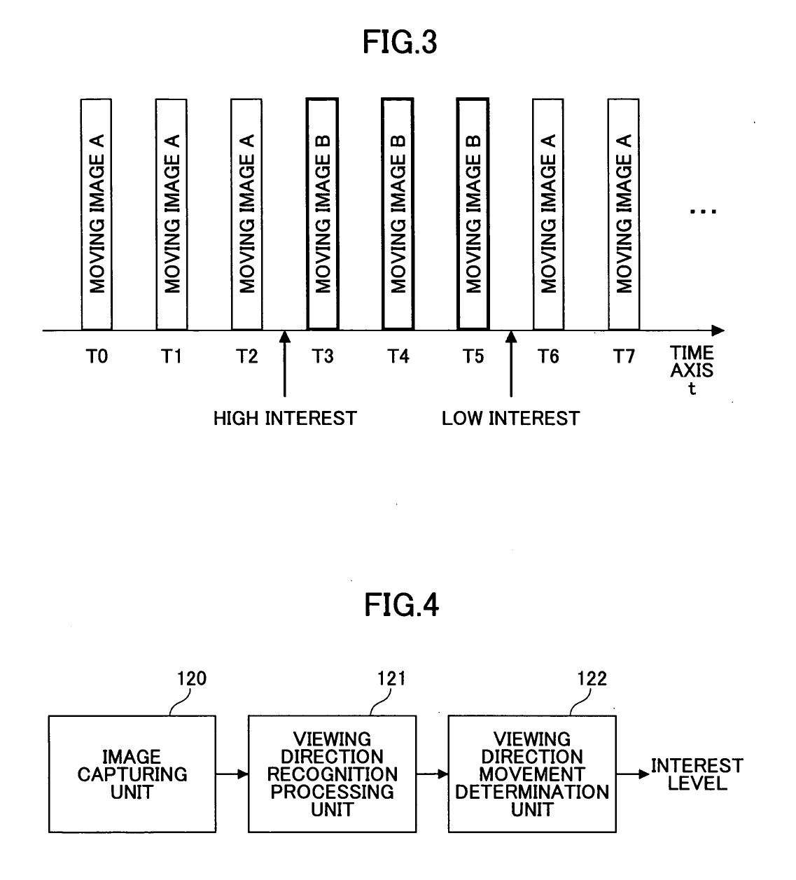

It is noted that the switching of a moving image as is described above has to be performed in sync with the frame period as is illustrated in FIG. 3. In FIG. 3, moving image A denotes a moving image with a small amount of motion, and moving image B denotes a moving image with a large amount of motion. This drawing schematically illustrates a case in which the moving image being displayed is switched from moving image A to moving image B in response to an increase in the interest level of the user to high level, after which the moving image being displayed is switched back to moving image A in response to a decrease in the interest level of the user to low level. However, when the switching of the moving images occurs too frequently at short periodic intervals, the image display may appear awkward to the user viewing the display screen. In order to prevent such a problem, the image selection control process of FIG. 2 is preferably performed at intervals of a predetermined number of frames (e.g., 150 frames). It is noted that the same type of problem may also occur when image switching between a three-dimensional image and a two-dimensional image or image switching between a moving image and a still image is performed too frequently at short periodic intervals. Thereby, the image selection control process of FIG. 2 is preferably performed at sufficiently long time intervals to avoid such a problem.

The interest level recognition unit 103 corresponds to means for determining whether the interest level of the user is high/low based on physiological reactions and specific behavior of the user, for example. The interest level recognition unit 103 may be realized by various techniques. For example, when the user has a high interest in the development of the game, the user normally tends to fix his/her eyes on the display screen of the image display unit 102 so that there tends to be little movement in the viewing direction of the user. In this respect, the interest level of the user may be determined based on the amount of movement in the viewing direction of the user. Also, it is noted that the pulse rate (heart rate) of the user tends to rise when his/her interest in the game increases. In this respect, the interest level of the user may be determined based on the pulse rate of the user. Also, in a pachinko machine, for example, the interest level of the user is expected to increase when a specific operations unit such as the so-called consecutive strike button or the consecutive shoot button is operated, and thereby, the interest level of the user may be determined based on the operational state (e.g., on/off state) of such operations unit.

FIG. 4 is a block diagram showing an exemplary configuration of the interest level recognition unit 103. In the illustrated example of FIG. 4, the interest level recognition unit 103 is configured to determine the interest level of a user based on the amount of movement in the viewing direction of the user, and includes an image capturing unit 120, a viewing direction recognition processing unit 121, and a viewing direction movement determination unit 122.

The image capturing unit 120 corresponds to means for capturing an image of the face of the user, and may correspond to a CCD camera provided in the image display apparatus, for example. The viewing direction recognition processing unit 121 corresponds to means for determining the viewing direction of the user based the image data input by the image capturing unit 120. The viewing direction movement determination unit 122 corresponds to means for calculating the amount of movement in the viewing direction of the user within a predetermined time period based on the viewing direction determined by the viewing direction recognition processing unit 121 and determining whether the calculated amount of movement exceeds a predetermined value. The determination result of the viewing direction movement determination unit 122 corresponds to the determination result of the interest level recognition unit 103. Specifically, the interest level of the user is determined to be high when the amount of movement of the viewing direction does not exceed the predetermined value, and the interest level of the user is determined to be low when the amount of movement of the viewing direction exceeds the predetermined value. This determination result, namely, a signal indicating whether the interest level of the user is high/low, is output as by the viewing direction movement determination unit 122 as an output signal of the interest level recognition unit 103.

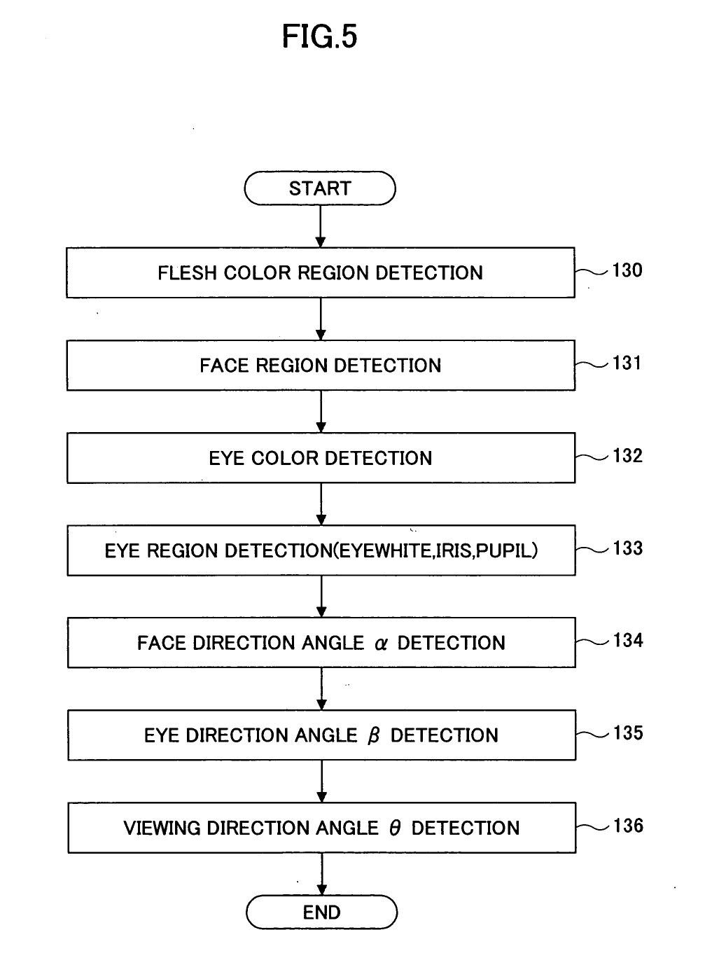

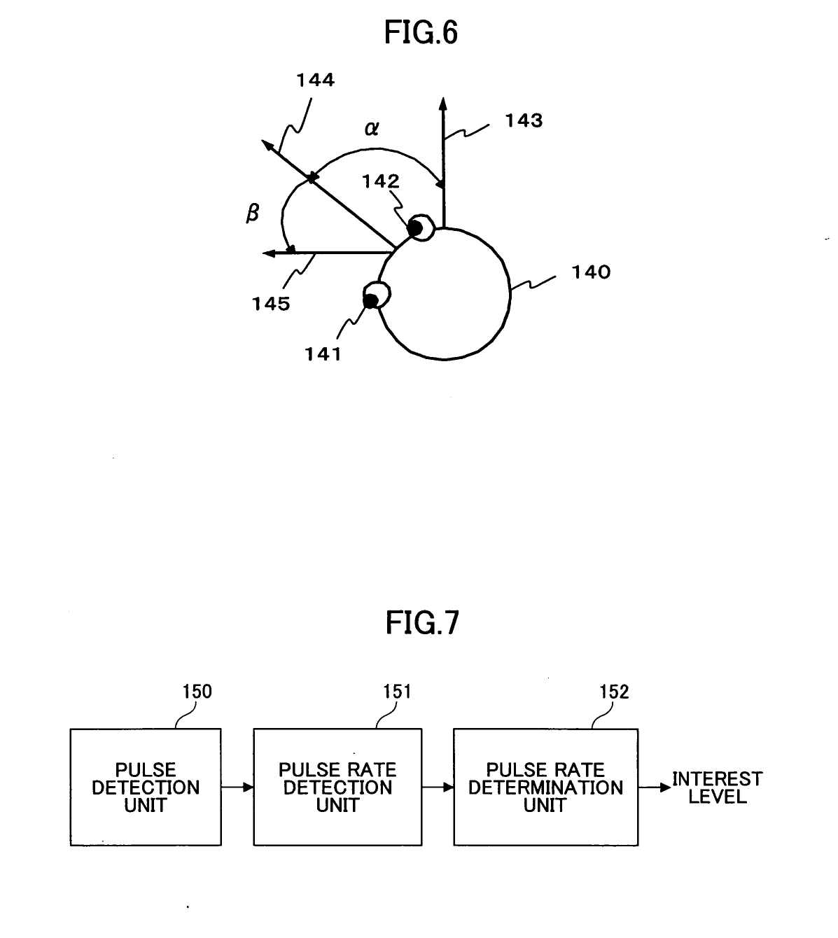

FIG. 5 is a flowchart illustrating an exemplary configuration of a viewing direction calculating algorithm used in the viewing direction recognition processing unit 121. FIG. 6 is a diagram illustrating a method of calculating the viewing direction of the user. In FIG. 6, a head 140 of a user in plan view, and eyes 141 and 142 of the user are shown. Also, FIG. 6 shows a viewing direction 143 when the user views a display image from directly opposite the display screen of the image display apparatus, a face direction 144 of the user, and a viewing direction (eye direction) 145 of the user when the user faces direction 144.

Referring to FIG. 5, in the viewing direction recognition process, first, flesh colored regions are detected based on image data of the image captured by the image capturing unit 120 (step 130). Then, a flesh colored region with the largest area of the detected flesh colored regions is detected as a face region (step 131). Then, eye color regions are detected from the face region (step 132). Then, two eye color regions with large areas are detected as eye regions from the eye color regions, and center positions of the detected eye regions as well as iris/pupil positions of the detected eye regions are detected (step 133). It is noted that the center position of the iris may be detected as the pupil position of a corresponding eye region. Then, an angle a formed between directions 144 and 143 (see FIG. 6) is calculated (step 134). It is noted that the face direction 144 corresponds to the direction of a line extending perpendicularly from a midpoint between the left eye and right eye with respect to a plane of the face region. Then, an angle β formed between the face direction 144 and the viewing direction (eye direction) 145 is calculated based on the deviation of the position of the pupil (or iris) from the center position of the eye region (step 135). Then, the angles α and β are added to obtain the angle θ of the viewing direction 145 with respect to the direction 143 (step 136).

The viewing direction determination unit 122 obtains a difference (absolute value) between the angle θ at a first point in time and the angle θ at second point in time after a predetermined time from the first point in time as the amount of movement in the viewing direction, and compares the obtained difference with a predetermined value to determine whether the difference exceeds the predetermined value. It is noted that the amount of movement in the viewing direction may be accurately obtained by calculating the movement in the horizontal direction as well as the movement in the vertical direction and adding the horizontal movement and vertical movement together. However, according to the present example, the amount of movement of the viewing direction is merely used as a rough standard for determining whether the interest level of the user is high/low, and thereby, a viewing direction movement detection with high accuracy is not demanded and the amount of movement may be calculated based merely on movement in the horizontal direction or the vertical direction.

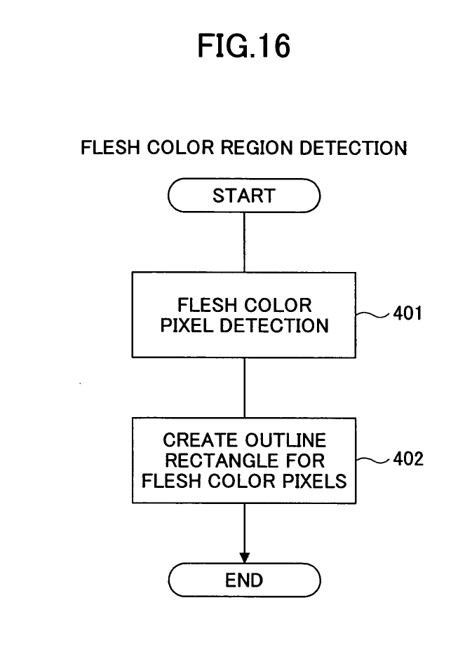

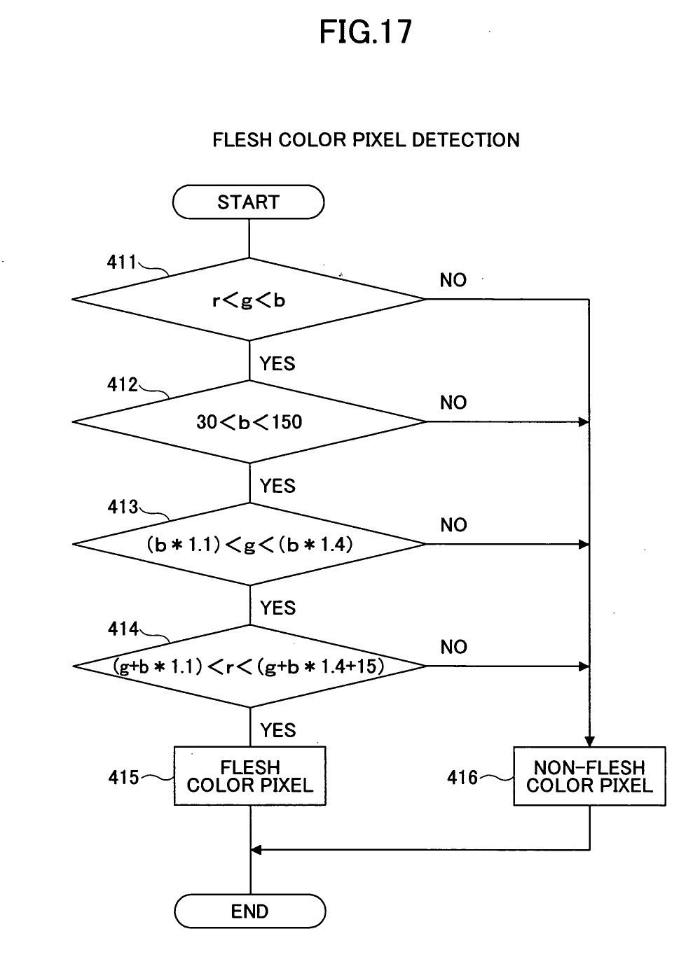

FIGS. 16 and 17 are flowcharts illustrating exemplary algorithms used in the flesh color region detection step 130 of FIG. 5. Referring to FIG. 16, in step 401, flesh color pixels are detected from pixels of the image data input by the image capturing unit 120. In a case where the image data are made up of R, G, and B components and each of the values r, g, and b is represented by an 8-bit value ranging between 0 through 255, a flesh color pixel and a non-flesh color pixel may be distinguished through a determination process as is illustrated in FIG. 17. It is noted that the determination conditions for the determination process according to the present example is based on the average flesh color of Japanese. The determination conditions may be suitably changed according to differences in ethnicity of potential users subject to the present determination process.

In step 411 of FIG. 17, the r, g, and b values of a subject pixel are checked in order to determine whether the subject pixel satisfies the condition “r<g<b”. If this condition is satisfied, a determination is made as to whether the condition “30<b<150” is satisfied in step 412. If this condition is satisfied, a determination is made as to whether the condition “b×1.1<g<b×1.4” is satisfied in step 413. If this condition is satisfied, a determination is made as to whether the condition “g+b×1.1<r<g+b×1.4+15” is satisfied in step 414. If this condition is satisfied; namely, if all the conditions of the determination steps 411 through 414 are satisfied, the subject pixel is determined to correspond to a flesh color pixel in step 415. If it is determined in any one of steps 411 through 414 that the subject pixel does not satisfy a corresponding condition, this pixel is determined to correspond to a non-flesh color pixel in step 416.

Referring back to FIG. 16, in step 402, rectangles each outlining a cluster of successive (i.e., adjacent or separated by a distance within a predetermined value) flesh color pixels are created. It is noted that the interior flesh color region within the outline rectangle that has the largest area among the rectangles created in step 402 is detected as the face region in step 131 of FIG. 5.

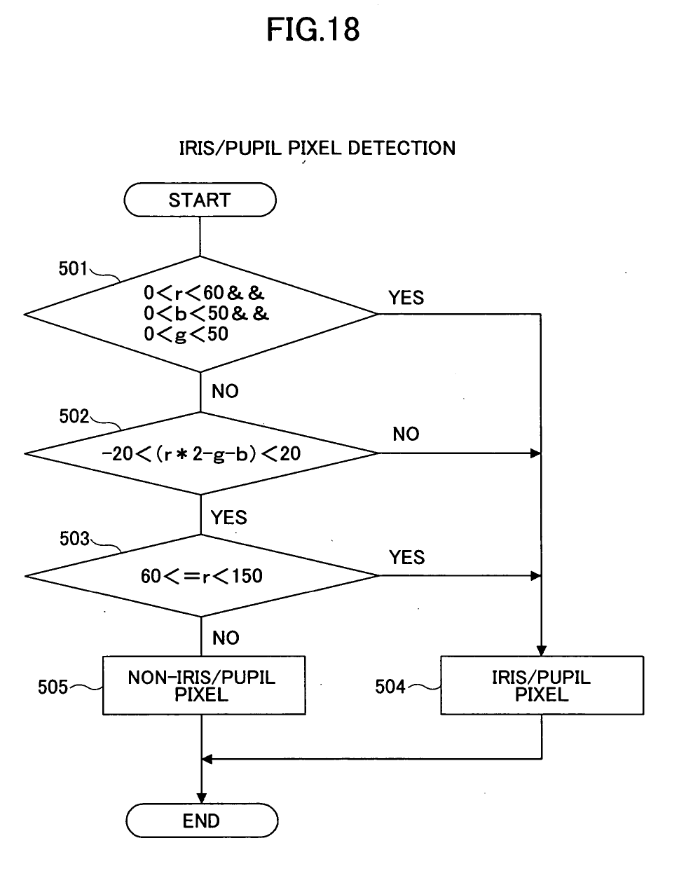

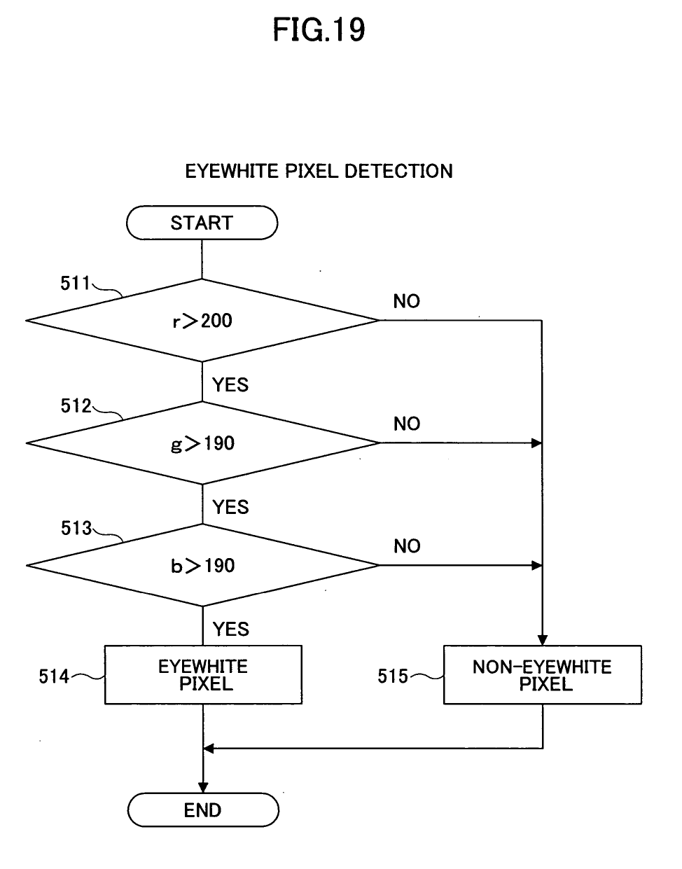

FIGS. 18 and 19 are flowcharts illustrating exemplary algorithms used in the eye color detection step 132 of FIG. 5. In step 132, color pixels corresponding to the colored portion of the eye (iris/pupil pixels) and pixels corresponding to the white portion of the eye (eyewhite pixels) are detected from the face region detected in step 131. FIG. 18 is a flowchart illustrating an exemplary iris/pupil pixel detection algorithm, and FIG. 19 is a flowchart illustrating an exemplary eyewhite pixel detection algorithm. In the illustrated example, it is assumed that each of the r, g, and b values of the R, Q and B components of a pixel are represented by an 8-bit value ranging between 0 through 255.

In the following, the iris/pupil pixel detection is described referring to FIG. 18. In step 501, a determination is made as to whether a subject pixel satisfies the condition 0<r<60 AND 0<b<50 AND 0<g<50”. If this condition is satisfied, the subject pixel is determined to correspond to an iris/pupil pixel in step 504. If the condition of step 501 is not satisfied, a determination is made as to whether the subject pixel satisfies the condition “−20<r×2−g−b<20” in step 502. If this condition is not satisfied, the subject pixel is determined to correspond to an iris/pupil pixel in step 504. If the condition of step 502 is satisfied, a determination is made as to whether the subject pixel satisfies the condition “60−≦r<150” in step 503. If this condition is satisfied, the subject pixel is determined to correspond to an iris/pupil pixel in step 504, whereas if this condition is not satisfied, the subject pixel is determined to correspond to a non-iris/pupil pixel in step 505.

Next, the eyewhite pixel detection is described referring to FIG. 19. In step 511, a determination is made as to whether a subject pixel satisfies the condition “r>200”. If this condition is satisfied, a determination is made as to whether the subject pixel satisfies the condition “g>190” in step 512. If this condition is satisfied, a determination is made as to whether the subject pixel satisfies the condition “b>190” in step 513. If this condition is satisfied, the subject pixel is determined to correspond to an eyewhite pixel in step 514. If any one of the conditions of steps 511 through 513 is not satisfied, the subject pixel is determined to correspond to a non-eyewhite pixel in step 515.

It is noted that the illustrated algorithms are based on average colors of irises/pupils and eyewhites of Japanese individuals. The determination conditions used in the algorithms may be suitably changed according to the ethnicity of potential users that may be subject to the present detection process.

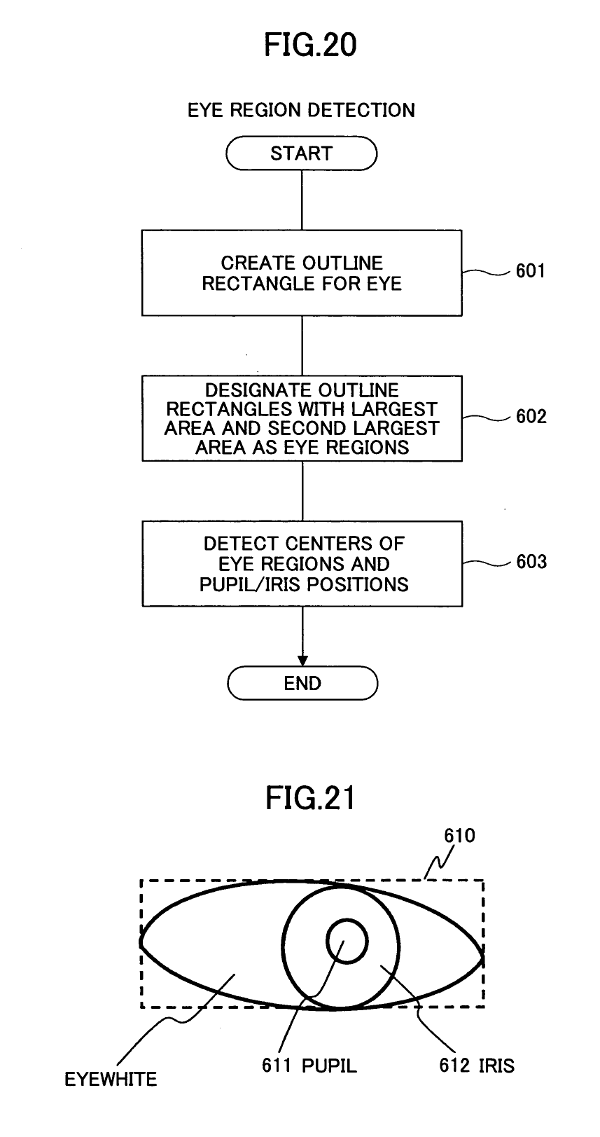

FIG. 20 is a flowchart illustrating an exemplary algorithm used in the eye region detection step 133 of FIG. 5. FIG. 21 is a diagram illustrating an exemplary eye region. Referring to FIG. 20, in step 601, rectangles each outlining a cluster of successive (adjacent or separated by a distance within a predetermined value) eye color pixels (i.e., iris/pupil pixels and eyewhite pixels) are generated. Then, in step 602, the outline rectangle with the largest area and the outline rectangle with the second largest area are determined to correspond to eye regions. In FIG. 21, a rectangular region 610 outlining an eye is shown, and this region 610 is detected as an eye region in step 602 of FIG. 20. It is noted that although two eye regions; namely, left and right eye regions are detected in step 602, only one of the eye regions is shown in FIG. 21. Then, in step 603, the center positions of the detected eye regions and positions of pupils 611 (or irises 612) corresponding to the center positions of clusters of iris/pupil pixels within the detected eye regions are detected.

The interest level recognition unit 103 based on the viewing direction of the user as is described above is advantageous in that it may be used in an image display apparatus that is not equipped with an operations unit that is constantly touched by the user or a specific operations unit from which operational state the interest level of the user may be estimated.

FIG. 7 is a block diagram illustrating another exemplary configuration of the interest level recognition unit 103. The interest level recognition unit 103 according to the present example is configured to determine whether the interest level of the user is high/low based on the pulse rate of the user, and includes a pulse detection unit 150, a pulse rate detection unit 151, and a pulse rate determination unit 152.

The pulse detection unit 150 may correspond to an optical pulse sensor, for example, that is configured to irradiate light on the hand/fingers of the user using a light emitting element such as a light emitting diode (LED), receive the reflected light or transmitted light of the irradiated light via a light receiving element such as a photo transistor, and output a signal according to the concentration of hemoglobin in the blood of the user, for example. The pulse rate detection unit 151 is configured to detect a pulse wave from the signal output by the pulse detection unit 150 and calculate the pulse rate of the user based on the time interval (period) of the pulse wave. The pulse rate determination unit 152 is configured to compare the pulse rate detected by the pulse rate detection unit 151 with a predetermined value to determine whether the interest level of the user is high/low. The determination result of the pulse rate determination unit 152 is output as the determination result of the interest level recognition unit 103. Specifically, when the pulse rate does not exceed the predetermined value, the interest level of the user is determined to be low, and when the pulse rate exceeds the predetermined value, the interest level of the user is determined to be high. A signal indicating such a determination result is output by the pulse rate determination unit 152 as an output signal of the interest level recognition unit 103, and this signal is then input to the display image selection unit 101.

An image display apparatus such as a game machine often includes an operations unit that is constantly touched by the hand/fingers of the user which operations unit may be provided in apparatus main body or a controller unit separated from the apparatus main body. For example, a pachinko machine includes a dial-type operations unit for adjusting the striking operation of pin balls. A mobile game apparatus includes a cross key that is almost always touched by the hand/fingers of the user. Accordingly, a pulse sensor as the pulse detection unit 150 may be incorporated into such an operations unit.

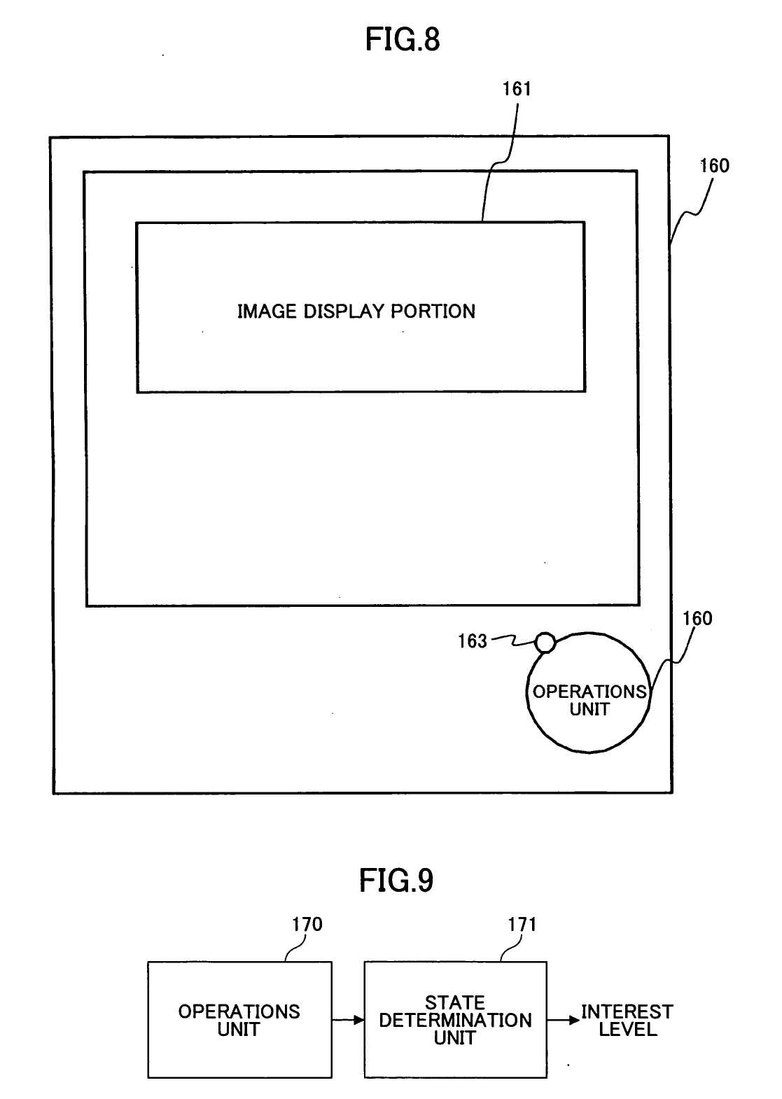

In the following, a pachinko machine that realizes interest level recognition based on pulse detection is described as an illustrative example. FIG. 8 is a front view of a pachinko machine. The illustrated pachinko machine includes an apparatus main body 160, an image display portion 161, a dial-type operations unit 162 that is normally operated by the right hand of the user in order to adjust the striking of pin balls, and a so-called consecutive strike button 163 that may be arranged at the operations unit 162 or the apparatus main body 160. In this pachinko machine, a pulse sensor as the pulse detection unit 150 (not shown) may be embedded into a periphery portion of the operations unit 162 that comes into contact with the hand/fingers of the user, for example. In this way, the pulse rate of the user may be detected and a determination may be made as to whether the current interest level of the user is high/low.

In a game apparatus that includes an apparatus main body or a controller unit that is gripped by the hand/fingers of the user, a pulse sensor may be arranged at the portion of the apparatus that is gripped by the hand/fingers of the user. Also, in an image display apparatus that uses earphones, the pulse sensor may be embedded in the earphones. In another example, the pulse sensor may be attached to the hand/fingers or the wrist of the user, and in such a case, a pressure-detecting pulse sensor may be used as well as an optical sensor.

FIG. 9 is a block diagram illustrating another exemplary configuration of the interest level recognition unit 103. The interest level recognition unit 103 according to the present example is configured to determine whether the interest level of the user is high/low based on the operational state of a specific operations unit that is operated by the user, and includes an operations unit 170 and a state determination unit 171.

The operations unit 170 may correspond to the consecutive strike button 163 of FIG. 8, for example. The operations unit 170 corresponds to a specific operations unit that is expected to raise the interest level of the user upon is operated. The state determination unit 171 is configured to determine the operational state (e.g., on/off state) of the operations unit 170. The determination result of the state determination unit 171 is output as the determination result of the interest level recognition unit 103. Specifically, when the operations unit 170 is determined to be in an operating state, the interest level of the user is determined to be high, and when the operations unit 170 is determined to be in a non-operating state, the interest level of the user is determined to be low. A signal indicating such a determination result is output by the state determination unit 171 as an output signal of the interest level recognition unit 103, which signal is then input to the display image selection unit 101.

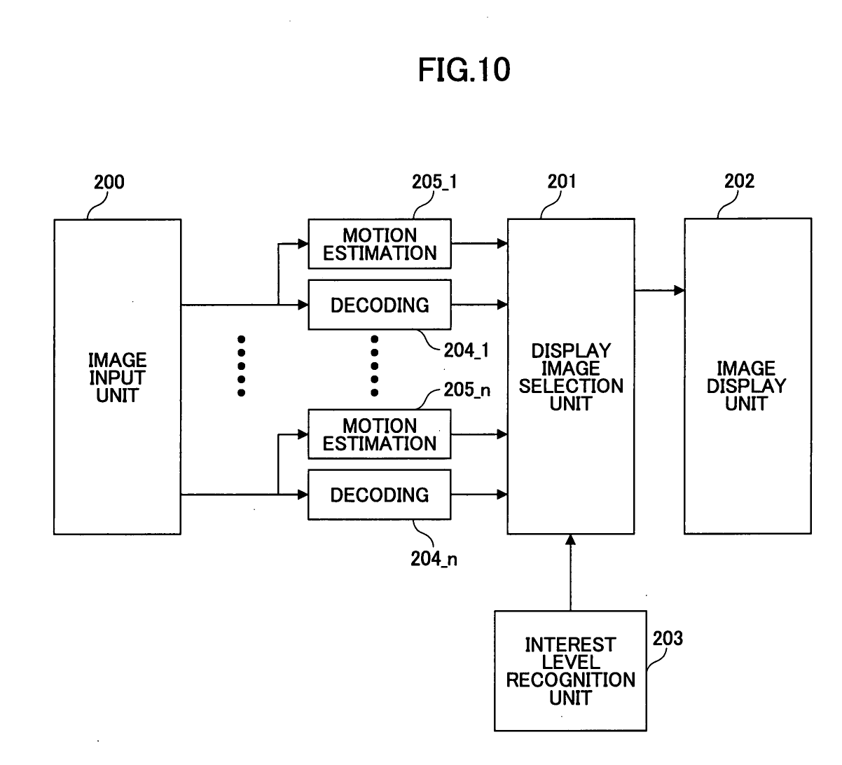

FIG. 10 is a block diagram illustrating a configuration of an image display apparatus according to a second embodiment of the present invention. The image display apparatus according to the present embodiment includes an image input unit 200 that is configured to input at least two moving images, a display image selection unit 201 that is configured to select (switch) a moving image to be displayed from the moving images input by the image input unit 200, and an interest level recognition unit 203 that is configured to determine whether the interest level of the user of the present image display apparatus is high/low. A signal indicating the interest level (high/low) of the user is output from the interest level recognition unit 203 to the display image selection unit 201.

According to the present embodiment, the moving images input by the image input apparatus 200 correspond to compressed code data, and in the illustrated image display apparatus of FIG. 10, at least two decoding units 204_1 through 204_n are provided for decoding the input moving images. However, it is noted that the number of decoding units 204 provided in the image display apparatus may be less than the number of moving images being input, and for example, one decoding unit 204 may be configured to decode plural moving images trough time division processing. Pixel data obtained by decoding the moving image at the decoding unit 204 are input to the display image selection unit 201.

In one example, the image input unit 200 may be configured to read the moving images from a large capacity storage device or a large capacity storage medium and input the read moving images.

In another example, the image input unit 200 may be configured to receive code data of the moving images via a network and input the received code data of the moving images. In this case, the received code data of the moving images may be temporarily stored in a storage device after which the code data may be read from the storage device and input, or the received code data of the moving images may be directly input. In the latter case, a decoding operation, a display image selection operation, and an image display operation are executed in parallel with the moving image receiving operation.

Also, according to the present embodiment, motion estimation units 205_1 through 205_n for estimating the amount of motion within the frames of the moving images are provided in the image display apparatus. In turn, signals indicating the amount of motion estimated by the motion estimation units 205 are input to the display image selection unit 201.

It is noted that the configuration of the interest level recognition unit 203 may be identical to the configuration of the interest level recognition unit 103 of the first embodiment (see FIG. 1), and thereby descriptions of the interest level recognition unit 203 are omitted.

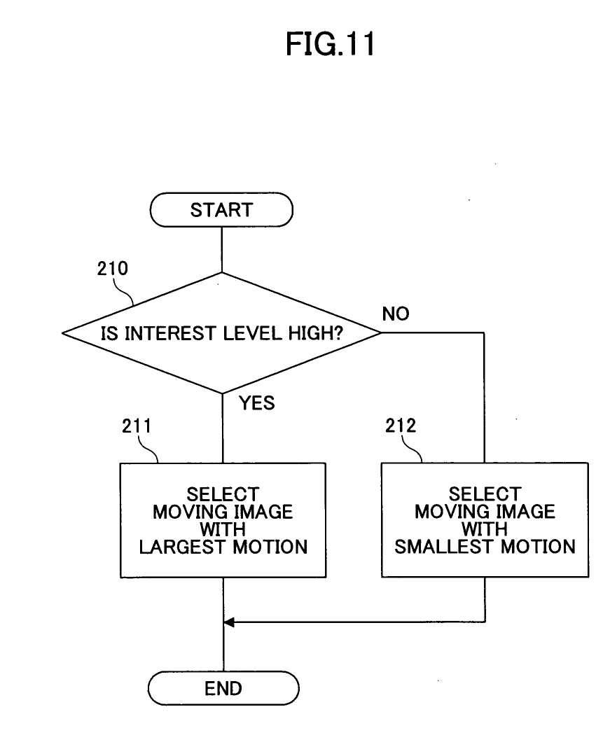

FIG. 11 is a flowchart illustrating an image selection control process that is performed by the display image selection unit 201. The display image selection unit 201 is configured to determine (e.g., at predetermined time intervals) whether the interest level of the user is high/low based on a signal input thereto by the interest level recognition unit 203 (step 210). If the interest level of the user is high (step 210, Yes), a moving image with the largest estimated motion is selected from the moving images input by the image input unit 200 (step 211). In other words, when the interest level of the user is high, a moving image with the largest estimated motion that may strain the eyes of the user but has the effect of increasing the excitement of the game is selected from the input moving imaged. On the other hand, when the interest level of the user is low (step 210, No), a moving image with the smallest estimated motion is selected from the input moving images (step 212). In other words, when the interest level of the user is low, reducing the strain on eyes of the user is prioritized and a moving image with a small amount of motion (slow motion) is displayed. In order to realize such an image selection control process as is described above, the display image selection unit 201 includes means for detecting the largest motion and the smallest motion based on the signals indicating the motion estimations for the input images supplied by the motion estimation units 205_1 through 205_n. Accordingly, in step 211, the moving image with the largest motion is selected, and in step 212, the moving image with the smallest motion is selected.

As is described above, the image selection control process of the present embodiment is similar to the image selection control process of the first embodiment as is illustrated in FIG. 3. However, it is noted that in the present embodiment, a moving image to be displayed is selected from at least two input moving images based on the amount of motion in the input moving images estimated at a given time rather than selecting an image from specific input images as in the first embodiment. Also, as is described in relation to the first embodiment, when display image switching occurs too frequently over short periodic intervals, the displayed image may appear awkward. Accordingly, in order to avoid such a problem, the motion estimation process and the image selection control process of FIG. 11 are preferably performed at intervals of a predetermined number of frames (e.g., 150 frames).

According to a modified example of the present embodiment, the decoding unit 204 may not be provided in the image display apparatus, and instead, decoding functions may be implemented in the image display unit 202 and the code data of the moving image selected by the image selection unit 201 may be input to the image display unit 202. According to another modified example, decoding functions may be implemented in the display image selection unit 201, and the display image selection unit 201 may be configured to select code data of the moving image to be displayed, decode the selected code data, and transmit the decoded data to the image display unit 202.

In the following, the motion estimation unit 205 is described. In the example described below, it is assumed that interlaced moving images coded by the Motion-JPEG 2000 scheme are input as the moving images. According to the Motion-JPEG 2000 scheme, intra-frame coding is performed on the frames of moving images using the JPEG 2000 algorithm. An outline of the JPEG 2000 compression algorithm is described below to enable a better understanding of motion estimation.

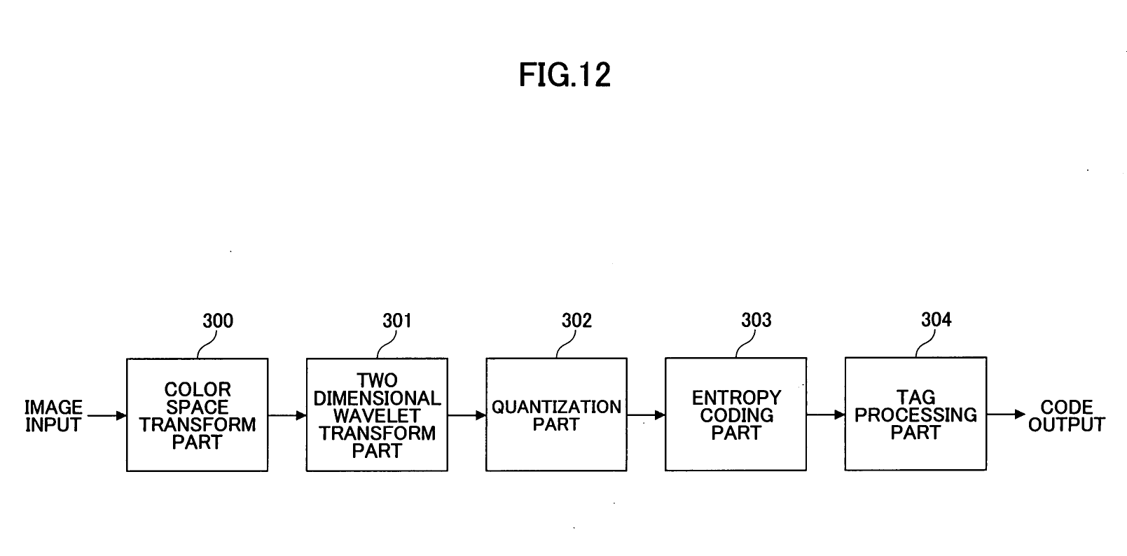

FIG. 12 is a block diagram illustrating the JPEG 2000 compression algorithm. The JPEG 2000 compression algorithm includes a color space transform unit 300, a two-dimensional wavelet transform unit 301, a quantization unit 302, an entropy coding unit 303, and a tag processing unit 304. In the JPEG 2000 coding scheme, an image is divided into non-overlapping rectangular regions (tiles), and the coding process is performed in tile units. For example, in the case of processing an RGB color image, color space transform is performed at the color space transform unit 300 on image data of each tile to convert the image data into YCbCr or YUV format. Then, at the two-dimensional wavelet transform unit 301, a two-dimensional wavelet transform (discrete wavelet transform) is applied on each component of the image data to divide each component into plural sub bands.

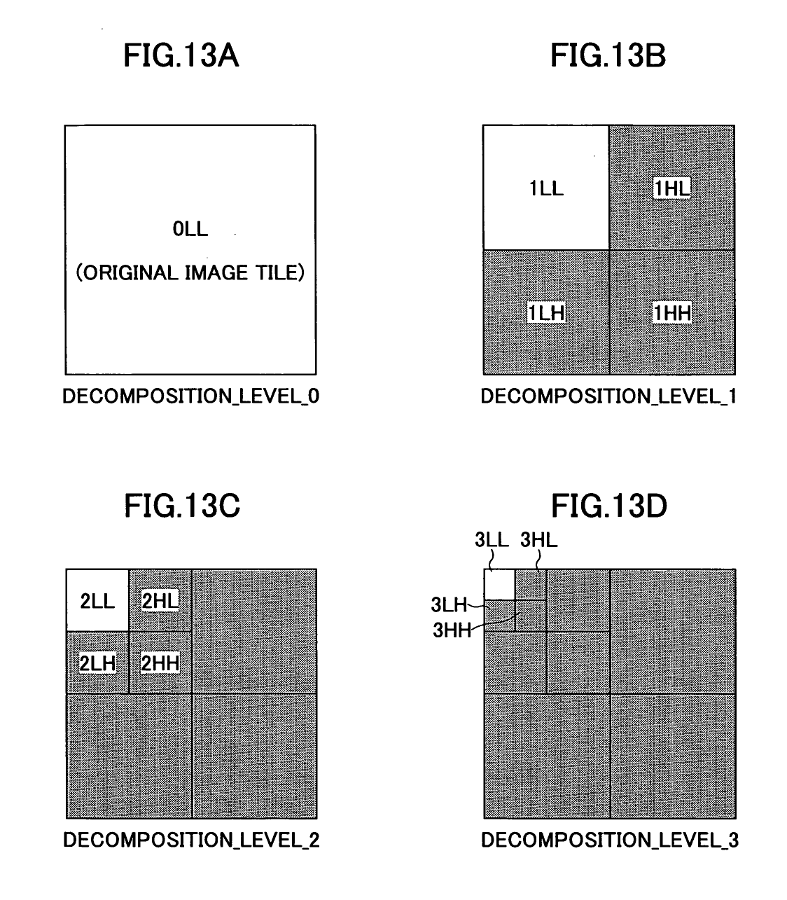

FIGS. 13A through 13D are diagrams illustrating the two-dimensional wavelet transform. Specifically, FIG. 13A shows an original tile image; FIG. 13B shows a case in which the two-dimensional wavelet transform is applied to the tile image of FIG. 13A so that the tile image is divided into 1LL, 1HL, 1LH, and 1HH sub bands; FIG. 13C shows a case in which the two-dimensional wavelet transform is applied to the 1LL sub band of FIG. 13B so that the 1LL sub band is divided into 2LL, 2HL, 2LH, and 2HH sub bands; and FIG. 13D shows a case in which the two-dimensional wavelet transform is applied to the 2LL sub band of FIG. 13C so that the 2LL sub band is divided into 3LL, 3HL, 3LH, and 3HH sub bands. It is noted that the numerals placed before the bands LL, HL, LH, and HH represent the so-called decomposition level indicating the number of wavelet transforms that are applied to obtain the coefficient of the corresponding sub band.

In a case where the irreversible 9×7 transform is used as the wavelet transform, linear quantization is performed at the quantization unit 302 with respect to each sub band so that the wavelet transform coefficient is linearly quantized. Then, bit-plane coding is performed on the wavelet transform coefficients with respect to each sub band at the entropy coding unit 303. Specifically, each bit-plane is divided into three sub bit-planes and coded thereafter. Then, at the tag processing unit 304, unnecessary codes are truncated from the obtained codes, necessary codes are packaged into packets, and a code stream is created by organizing the packets into a desired order and attaching tags or tag information to the packets. It is noted that in the case of using code data coded by the JPEG 2000 scheme as is described above, the amount of codes in each sub band may be easily calculated without having to decode the code data.

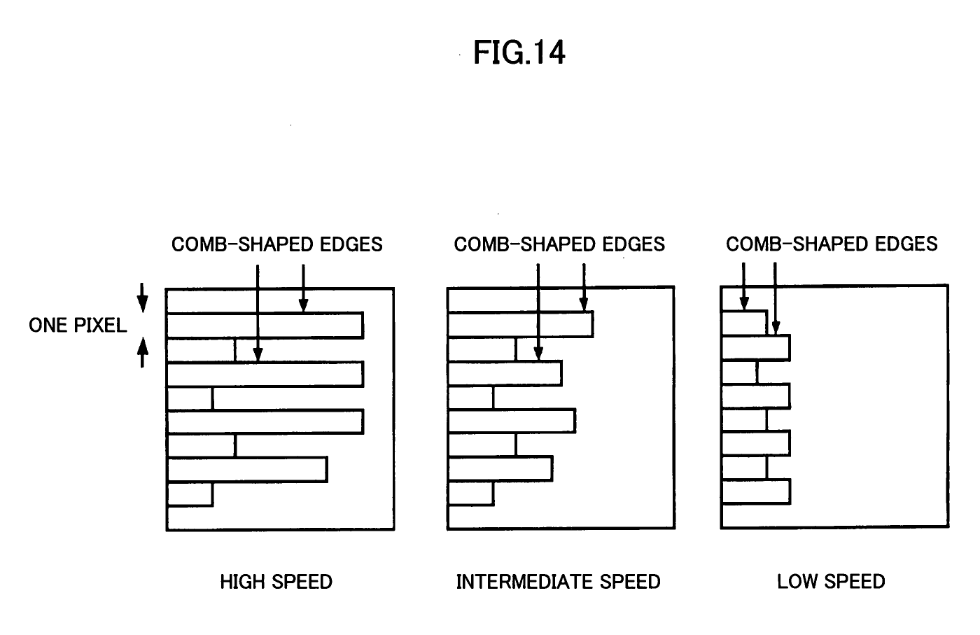

In the case of using an interlaced moving image in which each frame is divided into an odd field and an even field to be rendered through interlaced scanning, when an imaged object moves in a horizontal direction between the odd field and even field of a frame, comb-shaped horizontal direction edges are created in every other line at the vertical edge portion of the imaged object. It is noted that the dimension of the horizontal direction edges is proportional to the moving speed of the imaged object. FIG. 14 illustrates exemplary comb-shaped horizontal direction edges generated in cases where the imaged object moves at high speed, intermediate speed, and low speed. Since a large proportion of movement of an imaged object within a moving image captured by a video camera corresponds to movement in the horizontal directions, the dimension of the comb-shaped horizontal direction edges may be used as a scale for estimating the amount of motion within each frame of the moving image.

It is noted that the dimension of the horizontal direction edges is faithfully reflected in the code amount of the 1LH sub band of the code data of each frame; however, the code amount of the other sub bands are substantially uninfluenced by the occurrence of such horizontal direction edges. Accordingly, the amount of motion (moving speed of an imaged object) within a frame may be estimated based on the code amount of a specific sub band of the frame.

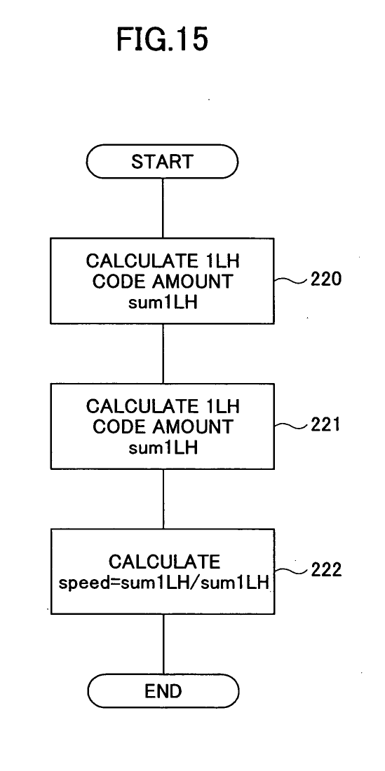

In one example, the motion estimation unit 205 may be configured to estimate the amount of motion in each frame using an algorithm as is illustrated in FIG. 15. In FIG. 15, first, a code amount ‘sum1LH’ of the 1LH sub band is calculated from code data of a frame of a moving image (step 220), and then, a code amount ‘sum1HL’ of the 1HL sub band is calculated (step 221). Then, an amount of motion ‘speed’ is calculated by dividing the code amount ‘sum1LH’ by the code amount ‘sum1HL’ (step 222). It is noted that the Y component (brightness component) is suitably used in the motion estimation as is described above. This is because color difference components are often skipped so that the comb-shaped edges are less likely to be represented even when movement occurs in the imaged object.

In another example, the motion estimation unit 205 may be configured to calculate code amounts ‘sum1LH’, ‘sum1HL’, ‘sum2LH’, and ‘sum2HL’ of the 1LH, 1Hl, 2LH, and 2HL sub bands, respectively, and obtain an estimated amount of motion by calculating: ‘speed=(sum1LH/sum1HL)/(sum2LH/sum2HL)’.

It is noted that the present invention is not limited to application of interlaced moving images that are intra-frame coded by the JPEG 2000 scheme, and the present invention may be equally applied with respect to moving images that are intra-frame coded by other coding schemes to realize motion estimation based on the code amount of a specific sub band.

Moreover, the present invention is not limited to a particular moving image coded by a particular coding scheme, and the moving image may be an interlaced moving image as well as a non-interlaced moving image, for example. That is, the moving image subject the present motion estimation may be coded by any coding scheme, and the motion estimation method may be changed accordingly as is necessary or desired.

Although preferred embodiments of the image display apparatus according to the present invention have been described above by illustrating a game apparatus such as a pachinko machine as an illustrative example, the present invention is obviously not limited these embodiments and may be applied to other various apparatuses having image display functions.

Also, according to an embodiment, one or more programs run on a computer such as a personal computer, a general purpose computer, or a microcomputer for operating the computer may be executed by the computer to realize the functions of the image display apparatus of the present invention. In such a case, the computer may embody the image display apparatus of the present invention. The one or more programs run on and executed by the computer and a computer-readable medium containing such programs are also included within the scope of the present invention. In the context of the present invention, a computer-readable medium can be any medium that can contain, store, or maintain the one or more programs described above for use by or in connection with an instruction execution system such as a processor in a computer system or other system. The computer-readable medium can comprise any one of many physical media such as, for example, electronic, magnetic, optical electromagnetic, infrared, or semiconductor media. More specific examples of a suitable computer-readable medium would include, but are not limited to, magnetic tapes, magnetic disks, magnetic hard drives, optical disks, magneto-optical disks, and semiconductor storage devices. Also, the computer-readable medium may be a random access memory (RAM) including, for example, static random access memory (SRAM) and dynamic access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It is noted that the above descriptions of the processes performed by the image display apparatus of the present invention correspond to descriptions of an image display control method of the present invention, and thereby, descriptions of such image display control method are ommitted

Further, the present invention is not limited to the above-described embodiments, and variations and modifications may be made without departing from the scope of the present invention.

What is claimed is:

1. An image display apparatus, comprising:
an image input unit to input a plurality of images;
a display image selection unit to select an image to be displayed from the images input by the image input unit;
an image display unit to display the image selected by the display image selection unit; and
an interest level recognition unit to determine whether an interest level of a user is high/low;
wherein the display image selection unit is operable to select the image to be displayed based on a determination result of the interest level recognition unit pertaining to the interest level of the user.

2. The image display apparatus as claimed in claim 1, wherein
the images input by the image input unit include a two-dimensional image and a three-dimensional image; and
the display image selection unit is operable to select the two-dimensional image when the interest level recognition unit determines that the interest level of the user is low, and select the three-dimensional image when the interest level recognition unit determines that the interest level of the user is high.

3. The image display apparatus as claimed in claim 1, wherein
the images input by the image input unit include a still image and a moving image; and
the display image selection unit is operable to select the still image when the interest level recognition unit determines that the interest level of the user is low, and select the moving image when the interest level recognition unit determines that the interest level of the user is high.

4. The image display apparatus as claimed in claim 1, wherein
the images input by the image input unit include a moving image with a small amount of motion and a moving image with a large amount of motion; and
the display image selection unit is operable to select the moving image with a small amount of motion when the interest level recognition unit determines that the interest level of the user is low, and select the moving image with a large amount of motion when the interest level recognition unit determines that the interest level of the user is high.

5. The image display apparatus as claimed in claim 1, wherein
the interest level recognition unit is operable to determine whether the interest level of the user is high/low based on an amount of movement in a viewing direction of the user.

6. The image display apparatus as claimed in claim 1, wherein
the interest level recognition unit is operable to determine whether the interest level of the user is high/low based on a pulse rate of the user.

7. The image display apparatus as claimed in claim 1, further comprising:
a specific operations unit that is operated by the user;
wherein the interest level recognition unit is operable to determine whether the interest level of the user is high/low based on an operational state of the specific operations unit.

8. An image display apparatus, comprising:
an image input unit to input a plurality of moving images;
a display image selection unit to select a moving image to be displayed from the moving images input by the image input unit;
an image display unit to display the moving image selected by the display image selection unit;
an interest level recognition unit to determine whether an interest level of a user is high/low; and
a motion estimation unit to estimate an amount of motion in each of the moving images;
wherein the display image selection unit is operable to detect a moving image with a smallest amount of motion of the input moving images based on the amount of motion in each of the moving images estimated by the motion estimation unit and select the moving image with the smallest amount of motion when the interest level recognition unit determines that the interest level of the user is low, and detect a moving image with a largest amount of motion of the input moving images based on the amount of motion in each of the moving images estimated by the motion estimation unit and select the moving image with the largest amount of motion when the interest level determination unit determines that the interest level of the user is high.

9. The image display apparatus as claimed in claim 8, wherein
the image input unit includes a receiving unit to receive the moving images via a network.

10. The image display apparatus as claimed in claim 9, wherein
the motion estimation by the motion estimation unit and the image selection by the display image selection unit are performed in parallel with the reception of the moving images by the image input unit.

11. The image display apparatus as claimed in claim 8, wherein
the moving images correspond to interlaced moving images coded by a coding scheme that uses two-dimensional wavelet transform; and
the motion estimation unit is operable to perform motion estimation based on a code amount of a specific sub band of each of the moving images.

12. The image display apparatus as claimed in claim 8, wherein
the interest level recognition unit is operable to determine whether the interest level of the user is high/low based on an amount of movement in a viewing direction of the user.

13. The image display apparatus as claimed in claim 8, wherein
the interest level recognition unit is operable to determine whether the interest level of the user is high/low based on a pulse rate of the user.

14. The image display apparatus as claimed in claim 8, further comprising:
a specific operations unit that is operated by the user;
wherein the interest level recognition unit is operable to determine whether the interest level of the user is high/low based on an operational state of the specific operations unit.

15. An image display control method for controlling an image display operation of an image display apparatus, the method comprising:
selecting an image to be displayed from a plurality of images; and
determining whether an interest level of a player is high/low;
wherein the image to be displayed is selected based on a determination result of determining the interest level of the user.

16. An image display control method for controlling an image display operation of an image display apparatus, the method comprising:
selecting a moving image to be displayed from a plurality of moving images;
estimating an amount of motion in each of the moving images; and
determining whether an interest level of a player is high/low;
wherein includes detecting a moving image with a smallest amount of motion of the moving images based on the amount of motion in each of the moving images that is estimated and selecting the moving image with the smallest amount of motion when the interest level of the user is determined to be low, and detecting a moving image with a largest amount of motion of the moving images based on the amount of motion in each of the moving images that is estimated and selecting the moving image with the largest amount of motion when the interest level of the user is determined to be high.

17. A computer-readable medium containing a program run which, when executed on a computer, causes the computer to control an image display operation by:
inputting a plurality of images;
selecting an image to be displayed from the input images;
displaying the selected image to be displayed; and
determining whether an interest level of a user is high/low;
wherein the image to be displayed is selected based on a determination result pertaining to the interest level of the user.

18. A computer-readable medium containing a program run which when executed on a computer, causes the computer to control an image display operation by
inputting a plurality of moving images;
select a moving image to be displayed from the input moving images;
displaying the selected moving image to be displayed;
determining whether an interest level of a user is high/low; and
estimating an amount of motion in each of the moving images;
wherein a moving image with a smallest amount of motion of the input moving images is detected based on the estimated amount of motion in each of the moving images and selected as the moving image to be displayed when the interest level of the user is determined to be low, and a moving image with a largest amount of motion of the input moving images is detected based on the estimated amount of motion in each of the moving images and selected as the moving image to be displayed when the interest level of the user is determined to be high.
